(19) United States
(12) Patent Application Publication
(10) Pub. No.: US 2022/0267602 A1
(43) Pub. Date: Aug. 25, 2022

(54) ANTI-AGING AGENTS FOR ASPHALT BINDERS

(71) Applicant: Ergon, Inc., Jackson, MS (US)

(72) Inventors: Ken Cooley, Hattiesburg, MS (US); Jerry Johnson, Hattiesburg, MS (US); Codrin Daranga, Madison, MS (US); Robert Dwayne Johnson, Brandon, MS (US)

(21) Appl. No.: 17/628,166

(22) PCT Filed: Jul. 15, 2020
(86) PCT No.: PCT/US2020/042166

§ 371 Date: Jan. 18, 2022

Related U.S. Application Data
(60) Provisional application No. 62/874,320, filed on Jul. 15, 2019.

(51) Int. Cl. C08L 95/00; E01C 19/48

(52) U.S. Cl. CPC C08L 95/00; E01C 19/48; C08L 2555/34; C08L 2555/64

(57) ABSTRACT

An asphalt mixture comprising an asphalt binder, wherein the asphalt binder comprises at least one of a virgin asphalt binder, a reclaimed asphalt binder material comprising asphalt pavement (RAP), or a reclaimed asphalt binder material comprising asphalt shingles (RAS) and an anti-aging agent having a hydroxyl value of greater than about 25 mg KOH/g.

### BACKGROUND

Asphalt pavement is one of the most recycled materials in the world, finding uses when recycled in shoulders of paved surfaces and bridge abutments, as a gravel substitute on unpaved roads, and as a replacement for virgin aggregate and binder in new asphalt pavement. Typically, use of recycled asphalt pavement is limited to sub-surface pavement layers or to controlled amounts in asphalt base and surface layers. Such uses are limited in part because asphalt deteriorates with time, loses its flexibility, becomes oxidized and brittle, and tends to crack, particularly under stress or at low temperatures. These effects are primarily due to aging of the organic components of the asphalt, e.g., the bitumen-containing binder, particularly upon exposure to weather. The aged binder is also highly viscous. Consequently, reclaimed asphalt pavement has different properties than virgin asphalt and is difficult to process.

### SUMMARY

Disclosed are compositions and methods that may retard, reduce, or otherwise overcome the effects of aging in virgin or aged asphalt to preserve or rejuvenate some or all of the original properties of the virgin binder or virgin asphalt originally used. In some embodiments, the disclosed compositions and methods may alter the aging rate of the total binder present in an asphalt mixture containing virgin asphalt and reclaimed asphalt binder material comprising asphalt pavement (RAP), asphalt shingles (RAS), or both. The disclosed compositions and methods use modified asphalt anti-aging agents that are modified to contain high levels of free hydroxyl groups. Such modified anti-aging agents may improve the processing and performance properties within virgin, reclaimed, and highly oxidized asphalts. Additionally, incorporation of such anti-aging agents may slow the detrimental effects of aging of virgin asphalt, allow the use of higher amounts of recycled asphalt materials, or both.

In some embodiments, the disclosure describes an asphalt mixture comprising an asphalt binder, wherein the asphalt binder comprises at least one of a virgin asphalt binder, a reclaimed asphalt binder material comprising asphalt pavement (RAP), or a reclaimed asphalt binder material comprising asphalt shingles (RAS) and a modified anti-aging agent having a hydroxyl value of greater than about 25 mg KOH/g.

In some embodiments, the disclosure describes an asphalt mixture comprising an asphalt binder, wherein the asphalt binder comprises at least one of a virgin asphalt binder, a reclaimed asphalt binder material comprising asphalt pavement (RAP), or a reclaimed asphalt binder material comprising asphalt shingles (RAS) and a novel anti-aging agent having a hydroxyl value of greater than about 25 mg KOH/g, greater than 35 mg KOH/g, greater than 40 mg KOH/g, or greater than 50 mg KOH/g.

In another embodiment, the disclosure describes an asphalt mixture comprising an asphalt binder, wherein the asphalt binder comprises at least one of a virgin asphalt binder, a reclaimed asphalt binder material comprising asphalt pavement (RAP), or a reclaimed asphalt binder material comprising asphalt shingles (RAS) and a modified anti-aging agent derived from reacting an asphalt additive with one or more polyols or amine alcohols to increase a hydroxyl value of the additive, wherein the modified anti-aging agent provides a less negative ΔTc in aged asphalt containing the modified anti-aging agent after 40 hours of PAV aging at 100 degrees Celsius compared to a similarly-aged binder with the unmodified asphalt additive.

In another embodiment, the disclosure describes a method for improving the efficacy of an anti-aging agent for an asphalt mixture comprising reacting the anti-aging agent with one or more polyols or amine alcohols to increase a hydroxyl value of the anti-aging agent and form a modified anti-aging agent that provides a less negative ΔTc in aged asphalt containing the modified anti-aging agent after 40 hours of PAV aging at 100 degrees Celsius compared to a similarly-aged binder with the unmodified anti-aging agent.

In another embodiment, the disclosure describes a method forming a modified anti-aging agent for an asphalt mixture comprising reacting one or more of tall oil, a fatty acid, or vegetable oil at a temperature of less than about 200 degrees Celsius with one or more polyols or amine alcohols to increase a hydroxyl value of the tall oil to at least 25 mg KOH/g.

In another embodiment, the disclosure describes a method for slowing the aging or restoring aged asphalt binder comprising adding a modified anti-aging agent to an asphalt binder, wherein the asphalt binder comprises at least one of a virgin asphalt binder or a reclaimed asphalt binder material comprising asphalt pavement (RAP) or asphalt shingles (RAS) and wherein the modified anti-aging agent has a hydroxyl value of greater than about 25 mg KOH/g.

In another embodiment, the disclosure describes a method for improving the efficacy of a asphalt additive as an anti-aging agent for an asphalt mixture comprising reacting the asphalt additive comprising one or more carbonyl groups with one or more polyols or amine alcohols to form a modified anti-aging agent having a hydroxyl value of greater than about 25 mg KOH/g, and adding the modified anti-aging agent to an asphalt binder to form an asphalt mixture, wherein the asphalt binder comprises at least one of a virgin asphalt binder, a reclaimed asphalt binder material comprising asphalt pavement (RAP), or asphalt shingles (RAS).

The above summary of the disclosure is not intended to describe each embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### ABBREVIATIONS, ACRONYMS & DEFINITIONS

“Aged” refers to asphalt or binder that is present in or is recovered from reclaimed asphalt. Aged binder has high viscosity compared with that of virgin asphalt or virgin binder as a result of aging and exposure to outdoor weather. The term “aged” also refers to virgin asphalt or virgin binder that has been aged using the laboratory aging test methods described herein (e.g. RTFO and PAV). “Aged” may also refer to hard, poor-quality, or out-of-specification virgin asphalt or virgin binder particularly virgin binders having a ring-and-ball softening point greater than 65° C. by EN 1427 and a penetration value at 25° C. by EN 1426 less than or equal to 12 dmm.

“Aggregate” and “construction aggregate” refer to particulate mineral material such as limestone, granite, trap rock, gravel, crushed gravel sand, crushed stone, crushed rock and slag useful in paving and pavement applications.

“Anti-aging agent” refers to an asphalt additive that can be combined with an aged asphalt binder or a virgin asphalt binder to retard the rate of aging of asphalt or binder, or to restore or renew the aged asphalt or aged binder to provide some or all of the original properties of virgin asphalt or virgin binder. In some embodiments, the anti-aging agent may include additives known by those in the industry. In other embodiments, the anti-aging agent may include novel compounds that have meet the criteria disclosed herein. The effectiveness of an asphalt additive as an anti-aging agent may be examined by comparing the ΔTc value of a binder mixture containing the anti-aging agent after 40 hours of PAV aging at 100 degrees Celsius compared to a similarly-aged binder without the anti-aging agent or, in the examples where the asphalt has undergone the disclosed modification to increase its hydroxyl value, with the unmodified asphalt additive.

“Asphalt” refers to a binder and aggregate and optionally other components that are suitable for mixing with aggregate and binder. Depending on local usage, the terms “asphalt mix” or “mix” may be used interchangeably with the term “asphalt.”

“Asphalt pavement” refers to compacted asphalt.

“Binder” refers to a highly viscous liquid or semi-solid form of petroleum. “Binder” can include, for example bitumen. The term “asphalt binder” is used interchangeably with the term “binder.”

“Bitumen” refers to a class of black or dark-colored (solid, semisolid, or viscous) cementitious substances, natural or manufactured, composed principally of high molecular weight hydrocarbons, of which asphalts, tars, pitches, and asphaltenes are typical.

“M-critical” or “Creep critical” grade refers to the low temperature relaxation grade of a binder. The creep critical temperature is the temperature at which the slope of the flexural creep stiffness versus creep time according to ASTM D6648 has an absolute value of 0.300. Alternatively the stiffness and creep critical temperatures can be determined from a 4 mm Dynamic Shear Rheometer (DSR) test or Bending Beam Rheometer (BBR).

“Modified anti-aging agent” is used to refer to compounds that have undergone a process to increase the hydroxyl value of the compound. In some embodiments, the modified anti-aging agent may include anti-aging agents know to those in the industry that undergo the disclosed possess to increase the hydroxyl value of the compound. In other embodiments, the modified anti-aging agents may include novel compounds not previously used in asphalt mixtures that have undergone a process to produce the hydroxyl value of the compound disclosed. In yet another embodiment, the modified anti-aging agents may include a combination of known and novel compounds. Reference to a “modified anti-aging agent” does not imply that the starting material must be a recognized or commercially available anti-aging agent or asphalt additive prior to undergoing the disclosed modification.

“Neat” or “Virgin” binders are binders not yet used in or recycled from asphalt pavement or asphalt shingles, and can include Performance Grade binders.

“PAV” refers to a Pressurized Aging Vessel. The PAV is used to simulate accelerated aging of asphalt or binder as described in ASTM D6521-13, Standard Practice for Accelerated Aging of Asphalt Binder Using a Pressurized Aging Vessel (PAV).

“Reclaimed asphalt” and “recycled asphalt” refer to RAP, RAS, and reclaimed binder from old pavements, shingle manufacturing scrap, roofing felt, and other products or applications.

“Reclaimed asphalt pavement” and “RAP” refer to asphalt that has been removed or excavated from a previously used road or pavement or other similar structure, and processed for reuse by any of a variety of well-known methods, including milling, ripping, breaking, crushing, or pulverizing.

“Reclaimed asphalt shingles” and “RAS” refer to shingles from sources including roof tear-off, manufacture's waste asphalt shingles and post-consumer waste.

“RTFO” refers to a Rolling Thin Film Oven. The RFTO is used for simulating the short-term aging of binders as described in ASTM D2872-12e1, Standard Test Method for Effect of Heat and Air on a Moving Film of Asphalt (Rolling Thin-Film Oven Test).

“S-Critical” or “stiffness critical” grade refers to the low temperature stiffness grade of a binder. The stiffness critical temperature is the temperature at which a binder tested according to ASTM D6648 has a flexural creep stiffness value of 300 MPa or as determined by either the Bending Beam Rheometer test or 4 mm DSR test as described in ΔTc.

SHRP refers to the Strategic Highway Research Program which develops new binder specifications in 1993.

“Softening agent” refers to low viscosity additives that ease (or facilitate) the mixing and incorporation of a recycled binder into virgin binder during an asphalt production process.

“Temp” is used in Tables and Figures as a contraction for the word Temperature.

“ΔTc” refers to the value obtained when the low temperature creep or m-value critical temperature is subtracted from the low temperature stiffness critical temperature.

The 4 mm dynamic shear rheometer (DSR) test and analysis procedures are described by Sui, C., Farrar, M., Tuminello, W., Turner, T., A New Technique for Measuring low-temperature Properties of Asphalt Binders with Small Amounts of Material, Transportation Research Record: No 1681, TRB 2010. See also Sui, C., Farrar, M. J., Harnsberger, P. M., Tuminello, W. H., Turner, T. F., New Low Temperature Performance Grading Method Using 4 mm Parallel Plates on a Dynamic Shear Rheometer. TRB Preprint CD, 2011, and by Farrar, M., et al, (2012), Thin Film Oxidative Aging and Low Temperature Performance Grading Using Small Plate Dynamic Shear Rheometry: An Alternative to Standard RTFO, PAV and BBR. Eurasphalt & Eurobitume 5th E&E Congress-2012 Istanbul (pp. Paper O5ee-467). Istanbul: Foundation Euraspalt.

All weights, parts and percentages are based on weight unless otherwise specified.

### DETAILED DESCRIPTION

In one aspect, the present disclosure provides an asphalt mixture that includes an asphalt binder and a modified anti-aging agent having a hydroxyl value of greater than about 25 mg KOH/g. The asphalt binder may include a virgin asphalt binder, a reclaimed asphalt binder material comprising asphalt pavement (RAP) or asphalt shingles (RAS), or combinations thereof

As asphalt ages, the binder within the asphalt oxidizes which negatively impacts the properties of the asphalt. For example, aging binder will often become more brittle particularly at low temperatures causing the asphalt to crack. Further the Penetration index of the asphalt will often increase. Characteristics of bitumen containing binder in reclaimed asphalt sources relative to virgin binders used in asphalt mixtures are shown in Table 1.

TABLE 1

| | | | Critical Low | | Critical Low | | |
|---|---|---|---|---|---|---|---|
| | | | temperature | | temperature | | |
| | | | grade based | | grade based | | |
| | | 4 mm | on 4 mm | | on 4 mm | 4 mm | |
| | | DSR | DSR | | DSR | DSR | |
| | High | S-critical | m-critical | | S-Critical | m-critical | |
| | temperature | Grade ° C., | Grade ° C. | ΔTc° C., | Grade ° C., | Grade ° C. | ΔTc° C., |
| Binder & | stiffness | 20 hr. | 20 hr. | 20 hr. | 40 hr. | 40 hr. | 40 hr. |
| source | grade, ° C. | PAV | PAV | PAV | PAV | PAV | PAV |
| PG 58-28 | 60.3 | −31.4 | −30.9 | −0.5 | −30.7 | −27.8 | −2.9 |
| PG 64-22 | 67.1 | −27.1 | −26.2 | −.9 | −25.8 | −23.2 | −2.6 |

| | | | Critical Low | |
|---|---|---|---|---|
| | | | temperature | |
| | | | creep grade | |
| | | | based on | |
| | | 4 mm DSR | 4 mm DSR | |
| Binder recovered | | S-critical | m-critical | |
| from RAP or RAS | | Grade | grade | ΔTc° C. |
| RAP 03-16-15-D | 85.0 | −25.5 | −22.3 | −3.2 |
| RAP 02-23-15-B | 89.5 | −25.3 | −21.3 | −4.0 |
| RAP 03-24-15-D | 98.8 | −22.4 | −17.1 | −5.3 |
| RAP 02-09-15-B | 87.5 | −27.8 | −26.2 | −1.6 |
| RAS 04-03-15-D | 158.2 | −27.5 | −0.3 | −27.2 |
| RAS 02-09-15-C | 137.7 | −25.7 | +9.7 | −35.4 |

Table 2 shows the high and low temperature properties of samples produced with virgin binders and bitumen recovered from post-consumer waste shingles after different periods of aging. Also shown in Table 2 are high and low temperature properties of mixtures containing RAP and RAS. Some of these mixtures have undergone extended laboratory aging and some are from field cores.

TABLE 2

| | | Critical | Critical | |
|---|---|---|---|---|
| | | Low | Low | |
| Binder recovered from | | temperature | temperature | |
| RAP or RAS containing | High | stiffness | creep | |
| mixtures either lab or | temperature | grade based | grade based | |
| field aged | grade | on 4 mm DSR | on 4 mm DSR | ΔTc° C. |
| Field mix 09-27-13-F PG | 83.1 | −32.3 | −30.6 | −1.7 |
| 58-28 + 5% RAS, unaged | | | | |
| Field mix 09-27-13-E PG | 102.8 | −28.5 | −23.9 | −4.6 |
| 58-28 + 5% RAS, 5 day | | | | |
| aged @ 85° C. | | | | |
| US Hwy 14 PG 58-28 + | 85.4 | −30.9 | −24.1 | −6.8 |
| 6% RAS & 11% RAP, 10 | | | | |
| day aged @ 85° C. | | | | |
| US Hwy 14 PG 52-34 + | 80.8 | −35.6 | −29.9 | −5.7 |
| 6% RAS & 11% RAP, 10 | | | | |
| day aged @ 85° C. | | | | |
| US Hwy 14 PG 58-28 + | 79.5 | −29.6 | −26.7 | −2.9 |
| 31% RAP, 10 day aged | | | | |
| @ 85° C. | | | | |
| Core from field paved | 87.6 | −25.9 | −21.7 | −4.2 |
| 2011, cored 2013, binder | | | | |
| from top ½ inch of core | | | | |
| (mix contained PG 58-28 + | | | | |
| 5% RAS or 22% | | | | |
| shingle binder replacement) | | | | |
| Core from field paved | 86.0 | −25.6 | −21.9 | −3.8 |
| 2011, cored 2013, binder | | | | |
| from second ½ inch of | | | | |
| core below the surface | | | | |
| (mix contained PG 58-28 + | | | | |
| 5% RAS or 22% shingle | | | | |
| binder replacement) | | | | |
| Core from field paved | 80.7 | −26.0 | −24.2 | −1.8 |
| 2011, cored 2013, binder | | | | |
| from layer 2 inches | | | | |
| below surface (mix | | | | |
| contained PG 58-28 + | | | | |
| 5% RAS or 22% shingle | | | | |
| binder replacement) | | | | |

The last three rows of Table 2 show that the further away from the air-mixture interface, the lower the impact aging has on the ΔTc parameter. This parameter may be used to assess the impact of aging on binder properties and more specifically the impact of aging on the relaxation properties of the binder; the relaxation property is characterized by the property referred to as “low temperature creep grade.”

Research published in 2011 showed, based on recovered binder data from field cores, that ΔTc could be used to identify when a pavement reached a point where there was a danger of non-load related mixture cracking and also when potential failure limit had been reached. In that research the authors subtracted the stiffness-critical temperature from the creep or m-critical temperature and therefore binders with poor performance properties had calculated ΔTc values that were positive.

Since 2011 industry researchers have agreed to reverse the order of subtraction and therefore when the m-critical temperature is subtracted from the stiffness critical temperature binders exhibiting poor performance properties calculate to ΔTc values that are negative. The industry generally agreed that to have poor performing binders become more negative as performance decreased seemed to be more intuitive. Therefore, today in the industry and as used in the application, a ΔTc warning limit value is −3° C. and a potential failure value is −5° C.

Reports at two Federal Highway Administration Expert Task Group meetings have shown a correlation between ΔTc values of binders recovered from field test projects and severity of pavement distress related to fatigue cracking. Additionally, it has been shown that when binders used to construct these field test projects were subjected to 40 hours of PAV aging, the ΔTc values showed a correlation to pavement distress related to fatigue cracking, especially top down fatigue cracking which is generally considered to result from loss of binder relaxation at the bituminous mixture surface. It is therefore desirable to obtain asphalt mixtures with bitumen materials that have a reduced susceptibility to the development of excessively negative ΔTc values with age.

The data in Table 1 show typical virgin binders produced at refineries can maintain a ΔTc of greater than −3° C. after 40 hours of PAV aging. Further, the data in Table 1 show that binder recovered from RAP can have ΔTc values of less than −4° C., and that the impact of high RAP levels in new bituminous mixtures can further decrease the ΔTc values. Further, the extremely negative values of ΔTc for RAS recovered binders require additional scrutiny as to the overall impact of RAS incorporation into bituminous mixtures.

Table 2 shows that it is possible to age bituminous mixtures under laboratory aging followed by recovery of the binder from the mixtures and determination of the recovered binder ΔTc. The long term aging protocol for bituminous mixtures in AASHTO R30 specifies compacted mix aging for five days at 85° C. Some research studies have extended the aging time to ten days to investigate the impact of more severe aging. Recently, aging loose bituminous mixes at 135° C. for 12 and 24 hours and in some instances for even greater time periods have been presented as alternatives to compacted mix aging. The goal of these aging protocols is to produce rapid binder aging similar to field aging representative of more than five years in service and more desirably eight to 10 years in service. For example, it has been shown for mixtures in service for around eight years that the ΔTc of the reclaimed or recycled asphalt from the top ½ inch of pavement was more severe than 12 hours aging at 135° C. but less severe than 24 hours aging at 135° C.

The data in the first two rows of Table 2 show why long-term aging of mixtures containing recycled products is important. The binder recovered from the unaged mix (row 1) exhibited a ΔTc of −1.7° C., whereas the binder recovered from the 5 day aged mix exhibited a ΔTc of −4.6° C.

Tables 1 and 2 show the impact of incorporating high binder replacement levels of recycled materials, especially those derived from post-consumer waste shingles. While there is a desire to use such recycled materials, the impact of aged binders on the properties of such asphalt mixture has limited the amount of RAP and RAS materials incorporated. In some instances, government agencies have even set limits on the amounts of RAP and RAS materials that may be used in asphalt mixtures. Current asphalt paving practices involve the use of high percentages of RAP and RAS as components in the asphalt being paved. In some instances RAP concentrations can be as high as 50% and RAS concentrations can be as high as 6% by weight of the asphalt paving mixture. The typical binder content of RAP is in the range of 5-6% by weight and the typical binder content of RAS is in the range of 20-25% by weight. Consequently, a binder containing 50% by weight of RAP will contain 2.5% to 3% RAP binder contributed to the final binder mixture and a binder mixture containing 6% RAS by weight will contain 1.2% to 1.5% RAS binder contributed to the final binder mixture. In many instances RAP and RAS are combined in binder mixtures; for example 20% to 30% RAP and 5% to 6% RAS can be incorporated into a binder mixture. Based on the typical asphalt binder contents of RAP and RAS, asphalt binders containing 20% to 30% RAP and 5% to 6% RAS can result in 2% binder coming from the RAP and RAS combination to as much as 3.3% binder being derived from the RAP and RAS combination. Since a typical asphalt paving will contain about 5.5% total bitumen there can be about 36% to as much as 60% of the total bitumen in the bituminous mixture from these recycled sources.

To reduce or retard the impact of asphalt aging on the long-range performance of asphalt mixtures, many materials have been investigated with varying degrees of success. One class of materials are referred to as anti-aging agents or rejuvenators. These materials are often marketed with a stated goal of reversing the aging that has taken place in recycled raw materials such as RAP and RAS or slowing the aging effect in virgin binder. In some embodiments, anti-aging agents may help restore the rheological properties of aged asphalt binders, thereby allowing a greater percentage of the asphalt mixture to be formed of RAP or RAS materials. For example, the modified anti-aging agent may help in part by softening the aged binder to produce a workable asphalt mixture that in turn allows the mixture to be easily prepared, paved, and compacted. Additionally, or alternatively, the modified anti-aging agents may help slow or impede the aging effects on virgin binder allowing them to be used for a longer service period.

One group of anti-aging agents that have been explored include sterols. Sterols, also known as steroid alcohols, are a group of organic molecules often derived from natural sources such as plants, animals, fungi, or bacteria. Sterols have been found to help increase the ΔTc of aging binders thereby allowing the binder to retain its performance properties over a longer lifespan of the material. While sterols have shown promise as asphalt anti-aging agents, the costs associated with producing such materials can be comparatively high.

Another group of asphalt anti-aging agents include those acquired from bio-based sources including, for example, castor, cashew nut shell, rapeseed, soybean, sunflower, tall, vegetable, and other plant based oils. Some of these materials can be relatively inexpensive compared to sterols and easy to acquire, however many of these materials have been found to be poor anti-aging agents or suffer from other drawbacks. For example, vegetable oil has been found to help soften binders but is prone to leaching from rejuvenated asphalt causing the binder to resort back to its aged condition and can lead to rutting in the asphalt over time.

PCT International Patent Application Publication Number WO 2013\163463 A1 (Grady) entitled REJUVENATION OF RECLAIMED ASPHALT, explored the use of ester-functional anti-aging agents such as those derived from tall oil. Grady stated that by incorporating ester-functional groups into the anti-aging agents the glass-transition onset temperature of the binder may be reduced thereby improving the low-temperature and fatigue cracking resistance of the asphalt along with other properties. However, we have found that the high ester-functional tall oil derivatives disclosed by Grady have poor effects on the asphalt and tend to exhibit worse performance characteristics over time than the unmodified tall oil materials from which the high ester-functional derivatives are prepared. The low performance properties of the derivatives disclosed by Grady is believed to be due to the low hydroxyl content (e.g., low hydroxyl values) in the materials produced under the reaction parameters disclosed by Grady.

The presently disclosed modified anti-aging agents include carbonyl-containing materials such as tall oil, other plant based materials (e.g., raw materials or extracts sourced from plants), or other anti-aging agents that are modified as discussed in greater detail below to contain high levels of free hydroxyl groups (e.g., a hydroxyl value of at least about 25 mg KOH/g). Without being bound by theory, it is believed that increasing the number of free hydroxyl groups in such agents, for example by increasing the number of free hydroxyl groups in a tall oil material, increases the polarity of such anti-aging agents, making them more compatible and thus better suited to help soften and mix with the aging binders and other materials. For example, asphalt binders are a complex mixture of materials and while the mechanisms of aging are not completely understood, due to oxidation there is a general shift in the relative amount of aliphatic groups or segments in the binder materials toward more polar structures including, for example, the formation of ether, peroxide, and alcohol groups within the aging binder materials. This shift causes the binder to become stiffer and more polar with age. We have found that by increasing the polarity of anti-aging agents such as tall oil or other carbonyl-containing agents by increasing the relative number of free hydroxyl groups within such compounds can significantly increases their efficacy as anti-aging agents. The thus-modified anti-aging agents appear to be more compatible with the aged binders and may help solvate and soften the aged binder to both decrease the M-critical and S-critical grades of the material as well as increase the ΔTc.

The disclosed modified anti-aging agents preferably can alter (e.g., reduce or retard) an asphalt binder aging rate, or can rejuvenate, restore or renew an aged or recycled binder to provide some or all of the properties of a virgin asphalt binder. The disclosed asphalt mixtures containing such modified anti-aging agents also may improve the processing and performance properties within virgin, reclaimed, and highly oxidized asphalts, which help in the preservation, recycling and reuse of asphalt or asphalt binders. In some embodiments, the disclosed modified anti-aging agents can alter or improve the physical and rheological characteristics such as stiffness, effective temperature range, and low temperature properties of an asphalt mixture.

Starting materials that may be used to derive the disclosed modified anti-aging agents preferably include accessible or available carbonyl groups capable of reacting with one or more hydroxyl groups of a polyol. Such starting materials may include those containing carboxylic acid groups that react with polyols to form ester linkages, or react with amine groups of an amine alcohol to form amide linkages. Example carbonyl containing compounds may include, but are not limited to, triglycerides such as various vegetable and natural oils, various tall oils, vegetable oils, or natural fatty acids, tall oil and gum rosin acids, mono acids, di acids, tri acids, esters, polyesters, and various amides. While the below examples primarily focus on tall oil as the starting material, the concepts disclosed herein need not be limited to tall oil.

Preferred starting materials include those with one or more reactive carbonyl groups (e.g., carboxylic acids, esters, and the like) and are relatively inexpensive to acquire. Such starting additives may include, but are not limited to, plant based materials such as castor, cashew nut shell, cottonseed, corn, peanut, rapeseed, rice bran, safflower, sarsaparilla root, soybean, sunflower, vegetable, wheat germ and other plant based oils; rosins and rosin acids; fatty acids; mixtures thereof and the like. Additionally, or alternatively, the starting materials may include one or more coal or petroleum based materials including, but not limited to, coal tar pitch, coal extracts, engine or lubricating oils, paraffin or naphthenic oils, derivatives or mixtures thereof, and the like. In some embodiments, the disclosed modification techniques also may be applied to other commercially available anti-aging agents and to commercially available asphalt additives when such agents and additives are capable of reacting with one or more hydroxyl groups of a polyol or the amine group of an amine alcohol to provide an agent or additive that will impart improved anti-aging properties to an asphalt mixture. In some embodiments, the available carbonyl group in the starting material may be increased through an oxygenation process or other synthesis technique.

The relative number of free hydroxyl groups in the starting material may be increased using a variety of techniques. In some embodiments, the number of free hydroxyl groups may be increased by reacting such anti-aging agents with one or more polyols or amine alcohols while controlling the reaction conditions and stoichiometric ratios of the materials to favor the addition of such polyols or amine alcohols without significantly consuming the available hydroxyl groups. Additionally, or alternatively, the hydroxyl value of the starting materials may be increased through a transesterification reaction or by using a different reaction mechanism, catalyst, or with different reactants.

The availability of free hydroxyl groups may be measured in terms of the hydroxyl value of the resultant compounds, for example by using ASTM method D1957-86 (1995). The disclosed modified anti-aging agents should have a resultant hydroxyl value of at least about 25 mg KOH/g, more preferably at least about 35 mg KOH/g, and most preferably at least about 50 mg KOH/g after reaction with the polyols or amine alcohols. For comparison, commercially available fatty acid esters and rosin acid esters typically have hydroxyl values that range from 0-5 mg KOH/g and 5-12 mg/KOH/g. Crude tall oil has a hydroxyl value on the order of about 1 mg KOH/g.

Additionally, or alternatively, the final hydroxyl value may be adjusted as needed to even higher or lower values to obtain the desired adjustment to ΔTc. In some embodiments, the modified anti-aging agents may have a sufficient hydroxyl value that provides a less negative ΔTc in aged asphalt containing the modified anti-aging agent after 40 hours of PAV aging at 100 degrees Celsius compared to a similarly-aged binder with the unmodified anti-aging agent. In some embodiments, the final hydroxyl value may be adjusted to, depending on the acid value of the starting material, the number or acid groups available within the starting molecules, number of hydroxyl groups within the selected polyols or amine alcohols, the initial polarity of the reactants, and the like.

In some embodiments, the disclosed modification process may reduce the acid number of the starting material. For example, reacting fatty acid materials with one or more polyols or amine alcohols may cause at least some of the carboxyl groups of the fatty acids to react with the polyols (e.g., through esterification) or amine alcohols (e.g., through amide formation) and lower the resultant acid number of the materials. In some embodiments, the modified anti-aging agents may have an acid value of less than about 100, less than about 70, less than about 30, or even lower values.

In some embodiments, the acid value of the starting materials may be initially increased to provide more reactive acid groups within the starting material for bonding with the disclosed polyols or amine alcohols. The acid values of the starting materials may be increased using a variety of techniques. For example, the starting materials may be reacted with an acid or anhydride (e.g., acrylic acid, adipic acid, fumaric acid, maleic acid, maleic anhydride, succinic acid, other diacids, and the like) to increase the number of carboxylic acid groups in the molecule through, for example, Diels-Alder addition or ester addition. The increase in available carboxylic acid groups may allow for additional bonding between the polyols or amine alcohols. Additionally, or alternatively, at least some of the available carboxylic acid groups of the starting materials may remain within the resultant modified anti-aging agent to, for example, serve other functions in the asphalt mixtures. For example, the carboxylic acid groups may help the asphalt binder bond to aggregate.

In some embodiments, the disclosed modification process may include a transesterification process to increase the hydroxyl value. For example, a starting material that includes one or more ester linkages (e.g., soybean oil or other plant based oil) may be reacted with a polyol using a transesterification catalyst. The polyol, having more than two hydroxyl groups, can replace an organic group at the ester linkage. One of the hydroxyl groups of the polyol will donated to the removed organic group to form a new alcohol in the process. The polyol (absent one of its hydroxyl groups) will be attached at the ester linkage of the modified starting material to provide one or more free hydroxyl groups.

In some embodiments, the disclosed modified anti-aging agents may include modified tall oil. Conventional tall oil is a byproduct of paper milling and includes a complex mixture of different compounds including various rosin and fatty acid materials including resin acids such as abietic acid and its isomers; various fatty acids including palmitic acid, oleic acid, and linoleic acid, fatty alcohols; sterols; and other alkyl hydrocarbon derivates. The composition of tall oil varies a great deal depending on supply source, level of refinement, and the like. A typical technique of quantifying the quality or refinement of tall oil is to refer to the acid number, level of fatty acid content, or both. Conventionally tall oil can be purchased with acid values ranging from about 100-200, or from about 125-165. Tall oil is available in many forms including for example crude tall oil and distilled or refined crude tall oil. Distillation of crude tall oil provides various isolated forms of fatty acids including highly saturated and volatile long-chain fatty acids known as tall oil heads, tall oil fatty acids including C8-C12 fatty acids having varying degrees of unsaturation, tall oil rosins or pitch which includes largely C18-C20 tricyclic monocarboxylic acid. Commercially distilled tall oil includes a mixture of mostly tall oil fatty acid and a varying proportion of tall oil rosin. In some embodiments, the modified anti-aging agents may be derived from crude tall oil, distilled tall oil, tall oil head, tall oil pitch, or a mixture thereof.

The hydroxyl value of tall oil, in particular the hydroxyl value of such fatty acids, resin acids, and similar compounds present in tall oil, may be increased by reacting tall oil under relatively low temperatures with polyols or amine alcohols. The hydroxyl groups or amine groups can react with one or more carbonyl groups (e.g., carboxylic acid groups) of the fatty acid and resin acids of tall oil to form an ester or amide linkage. While reaction conditions, times, and stoichiometry may be unique to the individual carbonyls and polyols used in the reaction, the reaction kinetics can be controlled to favor the addition of such polyols or amine alcohols while promoting the retention of a large quantity of residual hydroxyls through of the reaction temperatures and stoichiometric ratios. The disclosed reactions may be carried out at relatively low temperatures and with the exclusion of ester catalysts to help ensure that available hydroxyl groups are not consumed though subsequent crosslinking of side reactions thereby providing a high hydroxyl value in the resultant compound.

For reactions using polyols and fatty acids, the reaction temperatures may be less than 200° C. Temperatures in excess of 200° C. may promote the formation of ester groups and will significantly decrease the hydroxyl value of the resulting compounds.

For reactions using amine alcohols and fatty acids, the reaction temperatures may high enough to favor the amide reaction (e.g., about 150° C.) but generally less than the reaction temperature that favors esterification (e.g., more than about 180° C.). Temperatures in excess of 200° C. may promote the formation of ester groups and will significantly decrease the hydroxyl value of the resulting compounds.

Larger molecular weight starting materials (e.g., rosin acids and high molecular weight acids) and ester-based starting materials (e.g., polyesters, vegetable oil triglycerides, and the like) may require higher reaction temperatures, longer reaction times, or a reaction catalyst to react with the disclosed polyols or amine alcohols as compared to the lower molecular weight fatty acids discussed above.

Suitable polyols and amine alcohols that may be used in the disclosed reaction may include polyols containing two or more free hydroxyl groups or amines containing one or more hydroxyl groups including, but are not limited to, ethylene glycol, diethylene glycol, triethylene glycol, propylene glycol, dimethylolpropionic acid, glycerine, trimethylolpropane, neopentyl glycol, pentaerythritol, di-pentaerythritol, sorbitol, sucrose, polyethylene glycols, polypropylene glycols, methanolamine, dimethylethanolamine, ethanolamine, aminomethyl propanol, propanolamines, mixtures thereof and the like. In some embodiments, the source for hydroxyl groups may include polyethylene polyols such as a polyethylene glycol (PEG), polypropylene glycol or other polyalkylene glycol having a plurality of available and preferably terminal hydroxyl groups.

Exemplary polyalkylene glycols are miscible, soluble or dispersible in the starting material and include repeating units of ethyl oxide, propyl oxide, and/or butyl oxides of low to high molecular weight, e.g., having a number average molecular weight of from about 190 to about 8000 g/mole, and preferably greater than about 190 g/mole. Such polyalkylene glycols can include liquids as supplied, for example PEG 300 and PEG 400, respectively available from Dow Chemical Co. as CARBOWAX™ PEG 300 and CARBOWAX PEG 400; waxes; solids; or combinations thereof. Polyethylene polyols represent a preferred class of polyols that when reacted with starting materials such as tall oil provided modified agents exhibiting comparable rejuvenating properties at lower hydroxyl values compared to other polyols tested. Without being bound by theory, it is believed that the long chain polyether linkages of such materials may also help increase the polarity of the resultant anti-aging agents, thereby making the modified anti-aging agent more compatible the aging asphalt components and may slow the agglomeration of the oxidized molecules in the aged binder.

In some embodiments, the disclosed modified anti-aging agents can maintain a ΔTc value greater than or equal to −5° C. as the asphalt or asphalt pavement is aged. In some embodiments, the disclosed modified anti-aging agents can provide an asphalt binder with a ΔTc of greater than or equal to −5° C. after 40 hours of PAV aging at 100° C., or more preferably a ΔTc of greater than or equal to −3° C. In some embodiments, the disclosed modified anti-aging agents provide an asphalt binder with a more positive ΔTc value and a decreased R-Value following aging, when compared to a similarly-aged asphalt binder without the disclosed modified anti-aging agents or an aged binder made using similar but unmodified anti-aging agents or anti-aging agents having lower hydroxyl values.

Additionally, or alternatively, the disclosed modified anti-aging agents can alter, reduce or retard the degradation of rheological properties in binders containing recycled bituminous materials such as RAS and RAP. The disclosed modified anti-aging agents may be added to asphalt mixtures from about 0.5 to about 15 wt. %, about 1 to about 10 wt. %, or about 1 to about 3 wt. % relative to the amount of virgin binder in an asphalt. The amount used within an asphalt mixture may be dependent in part on the target specifications of the asphalt material, the amount of RAS or RAP included, or the requirements set by government regulations.

In some embodiments, the disclosure modified anti-aging agent maybe provided by a novel agent that has not been previously used as an anti-agent in the asphalt industry but manufactured to possess the disclosed high hydroxyl value (e.g., greater than about 25 mg KOH/g, greater than 35 mg KOH/g, greater than 40 mg KOH/g, or greater than 50 mg KOH/g) and provides the desired ΔTc disclosed herein. Such novel compounds may include polyols, aliphatic modified polyols, polyester polyols, polycarbonate polyols, or the like.

In one embodiment, the disclosed asphalt mixtures may include a blend of binders along with the modified anti-aging agents. In certain embodiments, the binder blend includes virgin binder and binder extracted from reclaimed asphalt. For example, the binder extracted from RAS material may be extracted from manufacturer asphalt shingle waste, from consumer asphalt shingle waste, or from a mixture of binders extracted from manufacturer and consumer asphalt shingle waste. In certain embodiments, a binder blend may include from about 60 wt % to about 95 wt % of virgin binder and from about 5 wt % to about 40 wt % of binder extracted from reclaimed asphalt such as RAS. In certain embodiments, the binder blend includes the addition of modified anti-aging agent from about 0.5 wt % to about 15.0 wt % of the virgin asphalt. In certain embodiments, the binder blend can include the addition of from about 0.2 wt % to about 1.0 wt % modified anti-aging agent. The disclosed modified anti-aging agent has been shown to improve high and low temperature properties and PG grading for both low and high temperature ends of RAS-containing asphalt binder blends.

The disclosed asphalt mixtures may be prepared by mixing or blending the disclosed modified anti-aging agent and the virgin binder to form a mixture or blend. The mixture or blend can be added to recycled asphalt materials (e.g. RAS and/or RAP) and aggregate. One of skill in the art will recognize that many sequences of adding and mixing components are possible. Also, asphalt can be prepared by applying mechanical or thermal convection. In one aspect, a method of preparing an asphalt involves mixing or blending the disclosed modified anti-aging agent with virgin asphalt at a temperature from about 100° C. to about 250° C. In some embodiments, the disclosed modified anti-aging agent is mixed with the virgin asphalt at a temperature from about 125° C. to about 175° C., or 180° C. to 205° C. In some embodiments, the asphalt is mixed with asphalt, RAS, RAP, or combinations of RAS and RAP, the disclosed modified anti-aging agent and aggregate.

The disclosed asphalt can be characterized according to ASTM specifications and test methods, in addition to many standard tests. For example, the disclosed asphalts and binders can be characterized using rheological tests (viz., dynamic shear rheometer, rotational viscosity, and bending beam).

At low temperatures (e.g., −10° C.), road surfaces need cracking resistance. Under ambient conditions, stiffness and fatigue properties are important. At elevated temperature, roads need to resist rutting when the asphalt becomes too soft. Criteria have been established by the asphalt industry to identify rheological properties of a binder that correlate with likely paved road surface performance over the three common sets of temperature conditions.

To determine the ΔTc parameter, a 4 mm dynamic shear rheometer (DSR) test procedure and data analysis methodology as described above can be used. The ΔTc parameter can also be determined using a BBR test procedure based on AASHTO T313 or ASTM D6648. It is important that when the BBR test procedure is used that the test is conducted at a sufficient number of temperatures such that results for the Stiffness failure criteria of 300 MPa and Creep or m-value failure criteria of 0.300 are obtained with one result being below the failure criteria and one result being above the failure criteria. In some instances for binders with ΔTc values less than −5° C. this can require performing the BBR test at three or more test temperatures. ΔTc values calculated from data when the BBR criteria requirements referred to above are not met may not be accurate.

The present application is further illustrated in the following non-limiting examples, in which all parts and percentages are by weight unless otherwise indicated.

### EXAMPLE 1

Preparation of crude tall oil modified anti-aging agent: Two representative modified anti-aging agents were prepared using crude tall oil and either glycerin or PEG 400 as the source of hydroxyl groups.

Sample #1 was prepared using 680 grams of crude tall oil having an acid number of approximately 160 and a hydroxyl number of approximately 1 mg KOH/g as determined by ASTM D1957-86 (1995). The crude tall oil was heated to approximately 70° C. to facilitate mixing, followed by adding approximately 320 grams of PEG 400 (Polyethylene ether glycol with molecular weight of 400 g/mole). The contents of the flask were heated to an elevated temperature of 180° C. to initiate a minor level of esterification reaction to join the PEG to the tall oil compounds but prevent the hydroxyl groups from being fully consumed in the reaction. Further, no esterification catalyst was used in the reaction in order to limit the extent of esterification that occurred. The reaction was held at the elevated temperature until an acid number of 65-85 is obtained. The resulting sample modified anti-aging agent had a hydroxyl value of approximately 35-60 mg KOH/g sample.

Sample #2 was prepared using 785 grams of crude tall oil having an acid number of approximately 160 and a hydroxyl number of approximately 1 mg KOH/g as determined by ASTM D1957-86 (1995). The crude tall oil was heated to approximately 70° C. to facilitate mixing, followed by adding approximately 215 grams of glycerin. The contents of the flask were heated to an elevated temperature of 180° C. to initiate a minor level of esterification reaction to join the glycerin to the tall oil compounds. No esterification catalyst was used in the reaction in order to limit the extent of esterification that occurred. The reaction was held at the elevated temperature until an acid number of 50-70 was obtained. Based on the stoichiometry and reaction conditions, the glycerin was expected to combine with tall oil such that only about 1-1.25 of the 3 glycerin hydroxyl groups reacted allowing about 1.75-2.0 of the hydroxyl groups to remain free. The resulting modified anti-aging agent had a hydroxyl value of approximately 45-75 mg KOH/g.

### EXAMPLE 2

To investigate the efficacy of the modified anti-aging agents of Example 1, five binders were produced and aged tested under various conditions. The binders were produced by mixing the components with a low shear Lightning mixer in a 1 gallon can at a temperature of 187.8° C.-204° C. (370-400° F.) for approximately 30 minutes.

Binder #1 consisted of only virgin binder PG64-22.

Binder #2 included 96% PG64-22 blended with 4% of the Sample #1 modified anti-aging agent.

Binder #3 included 92% PG64-22 blended with 8% of the Sample #1 modified anti-aging agent.

Binder #4 included 96% PG64-22 blended with 4% of the Sample #2 modified anti-aging agent.

Binder #5 included 92% PG64-22 blended with 8% of the Sample #2 modified anti-aging agent.

The high and low temperature properties of the resultant binders were measured using the 4 mm DSR test procedure for an unaged, RTFO aged samples according to AASHTO T-240, and PAV aged samples aged at 20 hrs at 100° C. according to AASHTO R28. The results are shown in Table 3.

TABLE 3

| | AASHTO | Test | | | | | |
|---|---|---|---|---|---|---|---|
| Properties | Method | Temp. | Binder 1 | Binder 2 | Binder 3 | Binder 4 | Binder 5 |
| Penetration, | T-49 | 25° C. | 64 | 121 | 240 | 111 | 161 |
| 100 g, 5 sec, | | | | | | | |
| dmm | | | | | | | |
| Rotational | T-316 | 135° C. | 0.398 | 0.285 | 0.209 | 0.29 | 0.221 |
| Viscosity, 3.00 | | | | | | | |
| Pa · s maximum. | | | | | | | |
| Values in Pa · s | | | | | | | |
| Unaged DSR, | T-315 | 52° C. | — | 3.15 | 1.44 | 3.63 | 1.98 |
| G*/Sin(delta), | | 58° C. | — | 1.37 | 0.656 | 1.55 | 0.868 |
| Values in kPa | | 64° C. | 1.32 | 0.636 | — | 0.715 | — |
| (specification | | 70° C. | 0.617 | — | — | — | — |
| min. 1.00 kPa) | | 76° C. | — | — | — | — | — |
| | | Pass/fail | 66.2 | 60.4 | 54.8 | 61.4 | 57 |
| | | (P/F) | | | | | |
| | | Temp. | | | | | |
| RTFO Mass | T-240 | | −0.024 | −0.396 | −0.637 | −0.282 | −0.417 |
| loss (%) | | | | | | | |
| RTFO DSR, | T-315 | 52° C. | — | 8.8 | 4 | 9.09 | 4.6 |
| G*/Sin(delta), | | 58° C. | — | 3.73 | 1.76 | 3.82 | 2.01 |
| Values in kPa | | 64° C. | 3.48 | 1.66 | — | 1.7 | — |
| (specification | | 70° C. | 1.56 | — | — | — | — |
| min. 1.00 kPa) | | 76° C. | — | — | — | — | — |
| | | P/F | 67.4 | 61.9 | 56.4 | 62.1 | 57.3 |
| | | Temp. | | | | | |
| PAV DSR, | T-315 | 28° C. | — | — | — | — | — |
| G*/Sin(delta), | | 25° C. | 4250 | 2350 | 1160 | 2570 | 1440 |
| Values in kPa | | 22° C. | 6260 | 3640 | 1870 | 3990 | 2320 |
| (specification | | 19° C. | — | 5490 | 2960 | 6010 | 3670 |
| max 5000 kPa) | | 16° C. | — | — | 4610 | — | 5700 |
| | | 13° C. | — | — | 7020 | — | — |
| | | P/F | 23.7 | 19.7 | 15.4 | 20.3 | 16.9 |
| | | Temp. | | | | | |

| | | | | | |
|---|---|---|---|---|---|
| Aging Index | 2.63 | 2.72 | 2.78 | 2.46 | 2.32 |
| (Passing RTFO/Unaged DSR values) | | | | | |
| UTI | 91 | 88.3 | 85.8 | 88.8 | 84.9 |
| Super-Pave True Grade | TG66.4 − | TG60.4 − | TG54.8 − | TG61.4 − | TG57 − |
| | 24.6 | 27.9 | 31.0 | 27.4 | 27.9 |

The P/F temperature for the heated binders in the unaged condition is the temperature at which the binder stiffness equals approximately 1 kiloPascal (kPa) when tested in accordance with AASHTO T-315. The P/F temperature for binders in the RFTO aged conditions is the heated temperature at which the binder stiffness equals approximately 2.2 kPa when tested in accordance with AASHTO T-315. The P/F temperature for binders in the RFTO aged conditions is the low temperature at which the binder stiffness equals approximately 5000 kPa when tested in accordance with AASHTO T-315. This convention is in keeping with typical SHRP PG grading practices. The results in Table 3 show that when no anti-aging agent is present in the sample the P/F temperature increases at a faster rate than when the modified anti-aging agent is present.

The ΔTc values were also measured using low temperature BBR testing according to AASHTO T-313 for PAV aged samples aged at 20 and 40 hrs at 100° C. The results for 20 and 40 hr aged samples are shown in Tables 4 and 5 respectively.

TABLE 4

| Properties | Test | | | | | |
|---|---|---|---|---|---|---|
| PAV 20 hrs at 100° C., 300 psi | Temp. | Binder 1 | Binder 2 | Binder 3 | Binder 4 | Binder 5 |
| Stiffness @ 60 sec., | −6° C. | — | — | — | — | — |
| Values in MPa | | | | | | |
| (specification max 300) | | | | | | |
| m-value @ 60 sec | | — | — | — | — | — |
| Values in MPa/s | | | | | | |
| (specification min. 0.3) | | | | | | |
| Stiffness @ 60 sec., | −12° C. | 198 | 136 | — | 141 | — |
| Values in MPa | | | | | | |
| (specification max 300) | | | | | | |
| m-value @ 60 sec | | 0.325 | 0.378 | — | 0.368 | — |
| Values in MPa/s | | | | | | |
| (specification min. 0.3) | | | | | | |
| Stiffness @ 60 sec., | −18° C. | 392 | 304 | 200 | 325 | 238 |
| Values in MPa | | | | | | |
| (specification max 300) | | | | | | |
| m-value @ 60 sec | | 0.267 | 0.306 | 0.363 | 0.303 | 0.336 |
| Values in MPa/s | | | | | | |
| (specification min. 0.3) | | | | | | |
| Stiffness @ 60 sec., | −24° C. | — | 591 | 447 | 640 | 518 |
| Values in MPa | | | | | | |
| (specification max 300) | | | | | | |
| m-value @ 60 sec | | — | 0.244 | 0.288 | 0.236 | 0.269 |
| Values in MPa/s | | | | | | |
| (specification min. 0.3) | | | | | | |

| | | | | | |
|---|---|---|---|---|---|
| S-critical Temperature (° C.) | −15.7 | −17.9 | −21 | −17.4 | −19.8 |
| M-critical Temperature (° C.) | −14.6 | −18.6 | −23 | −18.3 | −21.2 |
| ΔTc for 20-hour PAV data | −1.1 | 0.7 | 2 | 0.9 | 1.4 |

TABLE 5

| Properties | Test | | | | | |
|---|---|---|---|---|---|---|
| PAV 40 hrs at 100° C., 300 psi | Temp. | Binder 1 | Binder 2 | Binder 3 | Binder 4 | Binder 5 |
| Stiffness @ 60 sec., | −6° C. | 123 | — | — | — | — |
| Values in MPa | | | | | | |
| (specification max 300) | | | | | | |
| m-value @ 60 sec | | 0.329 | — | — | — | — |
| Values in MPa/s | | | | | | |
| (specification min. 0.3) | | | | | | |
| Stiffness @ 60 sec., | −12° C. | 235 | 167 | — | 185 | 136 |
| Values in MPa | | | | | | |
| (specification max 300) | | | | | | |
| m-value @ 60 sec | | 0.289 | 0.33 | — | 0.32 | 0.357 |
| Values in MPa/s | | | | | | |
| (specification min. 0.3) | | | | | | |
| Stiffness @ 60 sec., | −18° C. | — | 328 | 245 | 381 | 306 |
| Values in MPa | | | | | | |
| (specification max 300) | | | | | | |
| m-value @ 60 sec | | — | 0.277 | 0.318 | 0.265 | 0.286 |
| Values in MPa/s | | | | | | |
| (specification min. 0.3) | | | | | | |
| Stiffness @ 60 sec., | −24° C. | — | — | 515 | — | — |
| Values in MPa | | | | | | |
| (specification max 300) | | | | | | |
| m-value @ 60 sec | | — | — | 0.26 | — | — |
| Values in MPa/s | | | | | | |
| (specification min. 0.3) | | | | | | |

| | | | | | |
|---|---|---|---|---|---|
| S-critical Temperature (° C.) | −14.3 | −17.2 | −19.6 | −16 | −15.7 |
| M-critical Temperature (° C.) | −10.4 | −15.4 | −19.9 | −14.2 | −14.6 |
| ΔTc for 40-hour PAV data | −3.9 | −1.8 | 0.3 | −1.8 | −1.1 |

For Binder #1 which did not include the presence of an anti-aging agent, the low temperature ΔTc under the BBR tests was comparatively less than any of the sample binders that included the Sample #1 or #2 modified anti-aging agents. All the binder samples that included the tested modified anti-aging agents exhibited a more positive ΔTc that would be compliant with most governmental regulations. All the ΔTc values for the 20 hr PAV aged binder samples with modified anti-aging agents were positive compared to pure PG64-22 which exhibited a ΔTc of −1.1. The ΔTc values for the 40 hr PAV aged binder samples with modified anti-aging agents likewise showed superiority over pure PG64-22 which had a ΔTc of −3.9 compared to the lowest ΔTc of −1.8 for the binder samples with modified anti-aging agents.

The data summarized in Tables 3-5 shows that the modified anti-aging agents with a high hydroxyl value had significant impact on both softness and the critical relaxation property related to the m-value, for aged binder samples.

### EXAMPLE 3

Preparation of soybean oil as a modified anti-aging agent through transesterification: Approximately 800 grams of soybean oil is added to a lab flask. The flask is heated to approximately 70° C. to facilitate mixing. Approximately 100 grams of glycerin and 5 grams of a transesterification catalyst (lithium ricinoleate) is then added to the flask. The contents of the flask is heated to approximately 250° C. for 2 hours and then heated to approximately 270° C. and held for 10 hours. The material is then steam sparged to remove any unreacted glycerin. The resulting compound has a hydroxyl value of greater than 100 mg KOH/g sample.

### EXAMPLE 4

Preparation of tall oil modified anti-aging agent with amine alcohol: Approximately 800 grams of the Sample #2 material having a hydroxyl value of 45-75 mg KOH/g is added to a lab flask and heated to approximately 70° C. to facilitate mixing. Approximately 20 grams of monoethanolamine is added to the flask. The contents of the flask is heated to about 140° C. and held 2 hours to promote amide formation. The resultant material is then steam sparged to remove any unreacted monoethanolamine. The lower temperature of the reaction promotes the amide formation while minimizing ester formation and thus preserving the hydroxyl groups. The resulting compound has a hydroxyl value of greater than 50 mg KOH/g.

### EXAMPLE 5

Preparation of tall oil modified anti-aging agent with amine alcohol: Approximately 800 grams of crude tall oil having an acid number of about 160 is added to a lab flask. The flask is heated to 70° C. to facilitate mixing followed by the addition of approximately 100 grams of monoethanolamine. The contents of the flask is heated to 140° C. and held 3 hours to promote amide formation. The material is then steam sparged to remove any unreacted monoethanolamine. The lower temperature of the reaction promotes the amide formation while minimizing ester formation and thus preserving the hydroxyl groups. The resulting compound has an acid number of about 60-90 and a hydroxyl value of greater than 65 mg KOH/g.

### EXAMPLE 6

Preparation of tall oil modified anti-aging agent with a polyol: Approximately 785 grams of crude tall oil having an acid number of about 160 and a hydroxyl number of approximately 1 is added to a lab flask and heated to approximately 70° C. to facilitate mixing. Approximately 24 grams of maleic anhydride is added to the flask. The contents of the flask is heated to about 205° C. and held for 2.5 hours to facilitate the formation of a Diels-Alder adduct. The contents of the flask is then cooled to about 180° C. followed by the addition of approximately 235 grams of glycerin to initiated a minor level of esterification reaction to join the glycerin to the tall oil adducts but prevent the hydroxyl groups from being fully consumed in the reaction. This temperature will initiate a small level of esterification reaction while also preserving the final hydroxyl content. Further, no esterification catalyst is used in the reaction in order to limit the extent of esterification that occurred. The reaction is held at the elevated temperature until an acid number of 70-90 is obtained. The resulting sample modified anti-aging agent has a hydroxyl value of approximately 60-95 mg KOH/g sample.

### EXAMPLE 7

Preparation of tall oil modified anti-aging agent with a polyol: Approximately 785 grams of crude tall oil having an acid number of about 160 and a hydroxyl number of approximately 1 is added to a lab flask and heated to approximately 70° C. to facilitate mixing. Approximately 315 grams of glycerin is added. The contents of the flask were heated to an elevated temperature of 180° C. and held for about 1.5 hours. The reaction mass is then heated to about 235° C. and held for 1 hour. The reaction mass is then heated to 270° C. and held until an acid number is less than about 10. The resulting sample modified anti-aging agent has a hydroxyl value of approximately 60-100 mg KOH/g sample.

The starting materials, polyols, and amine alcohols for any of the above examples of modified anti-aging agents may be substituted to include any material in accordance with the techniques disclosed herein. Additionally, any of the above example techniques may be changed or combined with other examples or techniques described herein.

### Comparative Example 1

Tall oil pitch: Experiments had been conducted relating to PG 64-22 blends that included 5 or 10% unmodified tall oil pitch. The tall oil pitch was obtained from Union Camp under the trade name Tallex, which is no longer commercially available. The sample blends were produced and aged for 20 and 40 hours in the PAV following ASTM D65217.

Binder #6 included 95% PG 64-22 plus 5% tall oil pitch.

Binder #7 included 90% PG 64-22 plus 10% tall oil pitch.

The Binder blends were produced by mixing the components with a low shear Lightning mixer in a 1 gallon can at a temperature of 187.8° C.-204° C. (370-400° F.) for approximately 30 minutes.

4 mm DSR testing was conducted at the aging conditions to determine the S-critical and M-critical low temperature grades of the blends at the different aging conditions. ΔTc, which is obtained by subtracting the M-critical low temperature value from the S-critical low temperature value was determined at each aging conditions.

TABLE 5

| | | S-critical | M-critical | |
|---|---|---|---|---|
| Binder | | Temperature | Temperature | |
| Aging | Binder | (° C.) | (° C.) | ΔTc |
| Unaged | PG 64-22 | −30.51 | −32.72 | 2.21 |
| Unaged | Binder 6 | −31.81 | −34.88 | 3.07 |
| Unaged | Binder 7 | −32.75 | −34.81 | 2.06 |
| 20 hr. PAV | PG 64-22 | −24.91 | −23.99 | −0.92 |
| 20 hr. PAV | Binder 6 | −25.346 | −25.5 | 0.16 |
| 20 hr. PAV | Binder 7 | −26.48 | −25.90 | −0.58 |
| 40 hr. PAV | PG 64-22 | −23.66 | −22.24 | −1.42 |
| 40 hr. PAV | Binder 6 | −23.952 | −22.0 | −2.00 |
| 40 hr. PAV | Binder 7 | −25.76 | −23.25 | −2.51 |

The data from Table 5 shows that the unmodified tall oil pitch in Binders #6 and 7 failed to improve the ΔTc (e.g., provide a more positive ΔTc) in the 40 hour PAV aged samples compared to PG 64-22 with no additive.

1. (canceled)

2. An asphalt-containing material comprising: an asphalt binder composition comprising:
an asphalt binder comprising at least one of a virgin asphalt binder, a reclaimed asphalt binder material comprising asphalt pavement (RAP), or a reclaimed asphalt binder material comprising asphalt shingles (RAS); and
an anti-aging agent derived from reacting an asphalt additive with one or more polyols or amine alcohols to increase a hydroxyl value of the additive, wherein the anti-aging agent has a hydroxyl value of greater than about 25 mg KOH/g and provides a less negative ΔTc in aged asphalt containing the anti-aging agent after 40 hours of PAV aging at 100 degrees Celsius compared to a similarly-aged binder with the unreacted asphalt additive.

3. (canceled)

4. A method for improving the efficacy of an anti-aging agent for an asphalt mixture comprising reacting the anti-aging agent with one or more polyols or amine alcohols to increase a hydroxyl value of the anti-aging agent and form a modified anti-aging agent that has a hydroxyl value of greater than about 25 mg KOH/g and provides a less negative ΔTc in aged asphalt containing the modified anti-aging agent after 40 hours of PAV aging at 100 degrees Celsius compared to a similarly-aged binder with the unreacted anti-aging agent.

5. A method for improving the efficacy of an asphalt additive as an anti-aging agent for an asphalt mixture comprising reacting a compound comprising one or more carbonyl groups with one or more polyols or amine alcohols to increase a hydroxyl value of the additive and form an anti-aging agent having a hydroxyl value of greater than about 25 mg KOH/g, and
adding the anti-aging agent to an asphalt binder to form an asphalt mixture, wherein the asphalt binder comprises at least one of a virgin asphalt binder, a reclaimed asphalt binder material comprising asphalt pavement (RAP), or a reclaimed asphalt binder material comprising asphalt shingles (RAS).

6. The asphalt mixture of claim 2, wherein the anti-aging agent has a hydroxyl value of greater than about 35 mg KOH/g.

7. The asphalt mixture of claim 2, wherein the anti-aging agent has a hydroxyl value of greater than about 50 mg KOH/g.

8. The asphalt mixture of claim 2, wherein the anti-aging agent has an acid value of less than about 100.

9. The asphalt mixture of claim 2, wherein the anti-aging agent is derived from a reaction product of a compound containing one or more carbonyl groups and one or more polyols or amine alcohols.

10. The asphalt mixture of claim 9, wherein the one or more polyols or amine alcohols comprises one or more of ethylene glycol, diethylene glycol, triethylene glycol, propylene glycol, dimethylolpropionic acid, glycerine, trimethylolpropane, neopentyl glycol, pentaerythritol, di-pentaerythritol, sorbitol, sucrose, polyethylene glycols, polypropylene glycols, methanolamine, dimethylethanolamine, ethanolamine, aminomethyl propanol, or propanolamines.

11. The asphalt mixture of claim 9, wherein prior to the reaction with the one or more polyols or amine alcohols, the compound is reacted with an acid or an anhydride to form a Diels-Alder adduct.

12. The asphalt mixture of claim 2, wherein the anti-aging agent is derived from a reaction product of a compound containing one or more carbonyl groups and one or more polyalkylene polyols.

13. The asphalt mixture of claim 12, wherein the one or more polyalkylene polyols comprise a polyalkylene glycol.

14. The asphalt mixture of claim 12, wherein the one or more polyalkylene polyols comprise polyethylene glycol or polypropylene glycol.

15. The asphalt mixture of claim 12, wherein the one or more polyalkylene polyols comprise liquid polyethylene glycol.

16. The asphalt mixture of claim 12, wherein the one or more polyalkylene polyols comprise wax or solid polyethylene glycol.

17. The asphalt mixture of claim 2, wherein the anti-aging agent is derived from a reaction product of a compound containing one or more carbonyl groups and one or more amine alcohols.

18. The asphalt mixture of claim 2, wherein the anti-aging agent is derived from one or more plant based materials, rosin acids, or fatty acids.

19. The asphalt mixture of claim 2, wherein the anti-aging agent is derived from one or more of castor oil, cashew nut shell oil, cottonseed oil, corn oil, peanut oil, rapeseed oil, rice bran oil, safflower oil, sarsaparilla root oil, soybean oil, sunflower oil, tall oil, vegetable oil, and wheat germ oil.

20. The asphalt mixture of claim 2, wherein the anti-aging agent is derived from at least one of tall oil, a resin acid, or a fatty acid.

21. The asphalt mixture of claim 2, wherein the anti-aging agent is derived from at least one of crude tall oil or tall oil pitch.

22. The asphalt mixture of claim 2, wherein the anti-aging agent comprises a compound derived from a coal based material.

23. The asphalt mixture of claim 2, wherein the anti-aging agent comprises a compound derived from a petroleum based material.

24. The asphalt mixture of claim 2, wherein the asphalt binder mixed with the anti-aging agent provides a ΔTc of greater than or equal to −5.0° C. after 40 hours of PAV aging at 100 degrees Celsius.

25. The asphalt mixture of claim 2, wherein the asphalt binder mixed with the modified anti-aging agent provides a ΔTc of greater than or equal to −3.0° C. after 40 hours of PAV aging at 100 degrees Celsius.

26. The asphalt mixture of claim 2, wherein the anti-aging agent is present in an effective amount to provide a more positive ΔTc value after 40 hours of PAV aging at 100 degrees Celsius compared to a similarly-aged binder without the anti-aging agent.

27. The asphalt mixture of claim 2, wherein the asphalt mixture comprises about 0.5 percent by weight (wt. %) to about 15 wt. % of the modified anti-aging agent relative to the asphalt binder.

28. The asphalt mixture of claim 2, wherein the asphalt binder comprises the reclaimed asphalt binder material comprising reclaimed asphalt pavement.

29. The asphalt mixture of claim 2, wherein the asphalt binder comprises the reclaimed asphalt binder material comprising reclaimed asphalt shingles.

30. The asphalt mixture of claim 2, further comprising an aggregate.

31. A method for applying a road pavement using the asphalt mixture of claim 30, wherein the asphalt mixture is applied to a base surface, and is compacted.

32. A method for making an anti-aging agent for an asphalt mixture comprising reacting tall oil at a temperature of less than about 200 degrees Celsius with one or more polyols or amine alcohols to increase a hydroxyl value of the tall oil to at least 25 mg KOH/g.

33. An anti-aging agent comprising tall oil reacted at a temperature of less than about 200 degrees Celsius with one or more polyols or amine alcohols to increase a hydroxyl value of the tall oil to at least 25 mg KOH/g.

34. An asphalt-containing material comprising:
an asphalt binder composition comprising:
an asphalt binder comprising at least one of a virgin asphalt binder, a reclaimed asphalt binder material comprising asphalt pavement (RAP), or a reclaimed asphalt binder material comprising asphalt shingles (RAS); and
an anti-aging agent that is a reaction product of ingredients including (i) a first material comprising a compound containing one or more carbonyl groups and (ii) a second material that reacts with the one or more carbonyl groups of the first material and adds hydroxyl groups to the reaction product, wherein the anti-aging agent has a hydroxyl value of greater than about 25 mg KOH/g.

35. A method for slowing the aging effects of an asphalt-containing material comprising:
forming an asphalt binder composition by adding an anti-aging agent to an asphalt binder, wherein the asphalt binder comprises at least one of a virgin asphalt binder, a reclaimed asphalt binder material comprising asphalt pavement (RAP) or a reclaimed asphalt binder material comprising asphalt shingles (RAS); and wherein the anti-aging agent is a reaction product of ingredients including (i) a first material comprising a compound containing one or more carbonyl groups and (ii) a second material that reacts with the one or more carbonyl groups of the first material and adds hydroxyl groups to the reaction product, wherein the anti-aging agent has a hydroxyl value of greater than about 25 mg KOH/g.
